(19) United States
(12) Patent Application Publication
(10) Pub. No.: US 2024/0157281 A1
(43) Pub. Date: May 16, 2024

(54) FILTER HOUSING FOR A FILTER SYSTEM AND FILTER SYSTEM WITH A FILTER HOUSING

(71) Applicant: MANN+HUMMEL GmbH, Ludwigsburg (DE)

(72) Inventors: Dennis STARK, Mauer (DE); Dominik BECK, Neustadt (DE)

(21) Appl. No.: 18/421,140

(22) Filed: Jan. 24, 2024

Related U.S. Application Data
(63) Continuation of application No. PCT/EP2022/057140, filed on Mar. 18, 2022.

(30) Foreign Application Priority Data
Jul. 26, 2021 (DE) 102021119325.7

(51) Int. Cl. B01D 46/71; B01D 46/00; B01D 46/24; B01D 46/64; F02M 35/02; F02M 35/10; F02M 35/024

(52) U.S. Cl. CPC B01D 46/71; B01D 46/0005; B01D 46/0045; B01D 46/2403; B01D 46/64; F02M 35/0202; F02M 35/10262; B01D 2279/60; F02M 35/02483

(57) ABSTRACT

A filter housing for a filter system for gaseous fluid has a housing wall with an inlet opening for a fluid to be filtered and an outlet opening for filtered fluid arranged in the housing wall. A receiving space inside the housing wall is provided for a filter element separating a raw side from a clean side between inlet and outlet openings upon intended mounting in the filter housing. An inflow guard is arranged at a housing segment provided with the inlet opening. The inflow guard is spaced radially from the housing segment and directed toward the receiving space. The inflow guard extends substantially only across the inlet opening. A filter system with such a filter housing has a purging device for intermittently emitting purging medium pressure surges from a clean side of the filter element arranged in the receiving space to a raw side of the filter element.

### CROSS-REFERENCE TO RELATED APPLICATIONS

This application is a continuation application of international application No. PCT/EP2022/057140 having an international filing date of 18 Mar. 2022 and designating the United States, the international application claiming a priority date of 26 Jul. 2021 based on prior filed German patent application No. 10 2021 119 325.7, the entire contents of the aforesaid international application and the aforesaid German patent application being incorporated herein by reference.

### BACKGROUND OF THE INVENTION

The invention concerns a filter housing for a filter system for filtering a gaseous fluid, in particular for a self-cleaning engine intake air filter system, as well as a filter system for filtering a gaseous fluid, in particular for a self-cleaning engine intake air filter system, with a filter housing.

DE 10 2019 132 361 A1 discloses a filter device which is used for gas filtration, for example, for filtration of air. The filter device comprises a filter housing and a filter element received in the filter housing and at least partially enclosing a flow space. The filter element comprises a filter body which is flowed through by the fluid to be purified radially from the exterior to the interior so that the inwardly positioned flow space which is at least partially enclosed by the filter body forms the clean space for receiving the purified fluid. The purified fluid received in the inwardly positioned flow space is discharged through a flow socket from the filter device. In the wall of the flow socket, at least one opening is provided, adjacent to which a fastening flange is arranged at the flow socket. The fastening flange serves for detachable fastening of a purging gas pipe of a purging device with which deposits can be cleaned off the filter body. Through the purging gas pipe of the purging device, a purging medium is introduced under pressure into the inwardly positioned flow space whereupon the deposits at the outer side of the filter body become detached by the pressure surge of the purging medium.

### SUMMARY OF THE INVENTION

It is an object of the invention to provide a filter housing for a filter system for filtering a gaseous fluid, in particular for a self-cleaning engine intake air filter system with which an efficient self-cleaning of the filter element is possible.

A further object is providing a filter system with such a filter housing.

The aforementioned object is solved according to an aspect of the invention by a filter housing for a filter system for filtering a gaseous fluid, in particular for a self-cleaning engine intake air filter system, with a receiving space for at least one filter element, with an inlet opening for a fluid to be filtered and an outlet opening for the filtered fluid which are arranged in a housing wall, wherein the at least one filter element is provided to separate a raw side from a clean side between inlet opening and outlet opening upon intended mounting, wherein at a housing segment which comprises the inlet opening an inflow guard is arranged which is spaced apart from the housing segment in radial direction and directed toward the receiving space and which extends substantially only across the inlet opening.

The further object is solved by a filter system for filtering a gaseous fluid, in particular for a self-cleaning engine intake air filter system, with a filter housing according to one of the preceding claims, with an inlet opening for a fluid to be filtered and an outlet opening for the filtered fluid which are arranged in a housing wall, as well as a receiving space for receiving a filter element, wherein a purging device is present which is configured for intermittent emission of a pressure surge of a purging medium from a clean side to a raw side of the filter element arranged in the receiving space, wherein a secondary filter element is arranged at the clean side of the filter element, wherein at a housing segment which comprises the inlet opening an inflow guard is arranged which is spaced apart from the housing segment in radial direction and directed toward the receiving space and which extends substantially only across the inlet opening.

Beneficial embodiments and advantages of the invention result from the additional claims, the description, and the drawing.

According to an aspect of the invention, a filter housing for a filter system for filtering a gaseous fluid is proposed, in particular for a self-cleaning engine intake air filter system, with a receiving space for at least one filter element, with an inlet opening for a fluid to be filtered and an outlet opening for the filtered fluid which are arranged in a housing wall, wherein the at least one filter element is provided to separate a raw side from a clean side between inlet opening and outlet opening upon intended mounting, wherein at a housing segment which comprises the inlet opening an inflow guard is arranged which is spaced apart from the housing segment in radial direction and directed toward the receiving space and which extends substantially only across the inlet opening.

Beneficially, the inflow guard, when the filter element is inserted, covers only a minimal portion of the filter element. The coverage is however sufficiently large in order to effect a cyclone movement about the filter element for a tangential inflow of the fluid to be purified. The rotary movement of the fluid to be purified about the filter element permits already the removal of a portion of the particles such as, for example, dust, pollen and the like, from the fluid to be purified. When it is desired to free the filter element from particles deposited at the exterior side, a large surface area at the raw side of the filter element can be cleaned due to the minimal coverage of the filter element by the inflow guard. This can be realized advantageously by means of a pressure surge which is directed opposite to the flow direction of the fluid to be purified in normal operation. Optionally, the inflow guard can be arranged at a circumferential edge of the housing, in particular of the housing top part, and can be formed as one piece together with this edge. The edge has only a minimal extension in axial direction and develops practically no effect with regard to the movement of the fluid to be purified about the filter element.

According to a beneficial embodiment of the filter housing, the inflow guard can have a length which amounts to at most 1.5 times the axial extension of the inlet opening in the housing wall along a longitudinal axis of the filter housing. Preferably, the length can amount to at most 1.3 times, particularly preferred at most 1.2 times, the axial extension of the inlet opening in the housing wall along a longitudinal axis of the filter housing. In case of a self-cleaning of the filter element in order to free it from deposited particles, a large outer surface area of the filter element can be cleaned.

According to a beneficial embodiment of the filter housing, the inflow guard can extend across at most 160° of a circumference of the housing segment. The inflow guard comprises an angle-limited extension about the longitudinal axis of the filter housing. Preferably, the inflow guard can extend across at most 120° of the circumference, particularly preferred at most across 100°, especially preferred at most across 90° of the circumference. In this way, a sufficient protection of a direct inflow of the filter element from the inlet opening in the filter housing is possible.

According to a beneficial embodiment of the filter housing, an outlet socket which is covered toward the receiving space by an additional inflow guard can be arranged in a housing segment. The outlet socket is arranged at the raw side of the filter element. Separated particles can be sucked away, for example, from the filter housing out of the outlet socket. The particles can collect between inflow guard and housing wall. For example, the outlet socket can be arranged in a region of the filter housing which is remote from the inlet opening.

Beneficially, an axial length of the additional inflow guard can amount to at most three times, preferably at most twice, an axial extension of the outlet socket in the housing wall along a longitudinal axis of the filter housing. Thus, deposited particles can be removed from a large exposed surface area at the raw side of the filter element.

In particular, the additional inflow guard can be designed to extend circumferentially in relation to an inner side of the housing wall. This permits a simple manufacture of the additional inflow guard.

Conventional inflow guard devices cover a significantly larger portion of the filter element in the region of the inlet opening as well as in the region of the outlet socket so that self-cleaning of the raw side of the filter element is inefficient. This can be avoided with the beneficial arrangement.

According to a beneficial configuration of the filter housing, in an outlet socket arranged at the outlet opening at least one receptacle for at least one purging device can be arranged. This permits an efficient self-cleaning of the filter element which can be freed from deposited particles by pressure surges.

According to a further aspect of the invention, a filter system for filtering a gaseous fluid is proposed, in particular for a self-cleaning engine intake air filter system, with a filter housing according to the invention, with an inlet opening for a fluid to be filtered and an outlet opening for the filtered fluid which are arranged in a housing wall, as well as a receiving space for receiving a filter element, wherein a purging device is present which is configured for intermittent emission of a pressure surge of a purging medium from a clean side to a raw side of the filter element arranged in the receiving space, wherein a secondary filter element is arranged at the clean side of the filter element, wherein at a housing segment which comprises the inlet opening an inflow guard is arranged which is spaced apart from the housing segment in radial direction and directed toward the receiving space and which extends substantially only across the inlet opening.

The relatively minimal coverage of the filter element at its outer side enables cleaning a large surface area of the filter element from deposited particles upon actuation of the purging device.

In order to be able to clean the filter body of the filter element in the filter system by self-cleaning action from deposits at the raw side, the filter system is provided with a purging device with which a purging medium, for example, a purging gas, is introduced at the clean side through an outlet opening of the filter system into the inwardly positioned flow space, flows through the wall of the filter body from the clean side to the raw side, and removes deposits at the raw side by means of a pressure surge. The purging device comprises a pipe elbow which passes through an opening in the wall of the outlet socket adjoining the outlet opening and is connected to the outlet socket.

The filter element is expediently coupled at its clean side to a secondary filter element. The pressure surge of the purging gas passes first through the secondary filter element whose filter medium, for example, is a nonwoven layer, before it impacts on the filter body of the filter element. The filter medium of the secondary filter element can be covered by a support element for stabilization of the nonwoven layer. In this way, bulging and thus possible tear formation of the filter medium can be avoided.

Advantageously, the support element can be a radially outwardly positioned protective net or grid, for example, of plastic material. In this way, the filter medium can be stabilized without at the same time effecting too large a pressure increase.

The filter element can be configured as a round element or, alternatively, as a flat element. The cross section of the round element can be circular, oval, or angular.

According to a beneficial embodiment of the filter system, the inflow guard can comprise a length which amounts to at most 1.5 times the axial extension of the inlet opening in the housing wall along a longitudinal axis of the filter housing. Preferably, the length can amount to at most 1.3 times, particularly preferred at most 1.2 times, the axial extension of the inlet opening in the housing wall along a longitudinal axis of the filter housing. Upon self-cleaning of the filter element in order to free it from deposited particles, a large outer surface area of the filter element can be cleaned.

As an alternative or in addition, the inflow guard can extend across at most 160° of a circumference of the housing segment. The inflow guard comprises an angle-limited extension about the longitudinal axis of the filter housing. Preferably, the inflow guard can extend across at most 120° of the circumference, particularly preferred at most across 100°, especially preferred at most across 90° of the circumference. In this way, a sufficient protection of a direct inflow of the filter element from the inlet opening in the filter housing is possible.

According to a beneficial embodiment of the filter system, an outlet socket which is covered toward the receiving space by an additional inflow guard can be arranged in a housing segment, in particular wherein an axial length of the additional inflow guard amounts to at most three times, preferably at most twice, an axial extension of the outlet socket in the housing wall along a longitudinal axis of the filter housing.

In this way, a large surface area of the raw side of the filter element is exposed so that the raw side can be freed efficiently from deposited particles upon actuation of the purging device.

### BRIEF DESCRIPTION OF THE DRAWINGS

Further advantages result from the following drawing description. In the drawings, embodiments of the invention are illustrated. The drawings, the description, and the claims contain numerous features in combination. A person of skill in the art will consider the features expediently also individually and combine them to expedient further combinations.

FIG. 1 shows a side view of a filter housing of a filter system for filtering a gaseous fluid, in particular for a self-cleaning engine intake air filter system, according to an embodiment of the invention.

FIG. 2 shows a perspective view of the filter housing of the filter system according to FIG. 1 with partially cutaway housing wall.

FIG. 3 shows a longitudinal section through the filter housing according to FIG. 1 with a view of an inserted filter element.

FIG. 4 shows a perspective view of a housing segment of the filter housing according to FIG. 1 with inlet socket and inflow guard.

FIG. 5 shows a further longitudinal section of the filter housing according to FIG. 1.

### DESCRIPTION OF PREFERRED EMBODIMENTS

In the Figures, same or same type components are identified with same reference characters. The Figures show only examples and are not to be understood as limiting.

Directional terminology used in the following with terms such as Aleft@, Aright@, Atop@, Abottom @, Ain front of@, Abehind@, Asubsequent@ and the like serve only for better understanding of the Figures and in no way are meant to represent a limitation of the generality. The illustrated components and elements, their configuration and use can vary in the context of considerations of a person of skill in the art and be adapted to the respective applications.

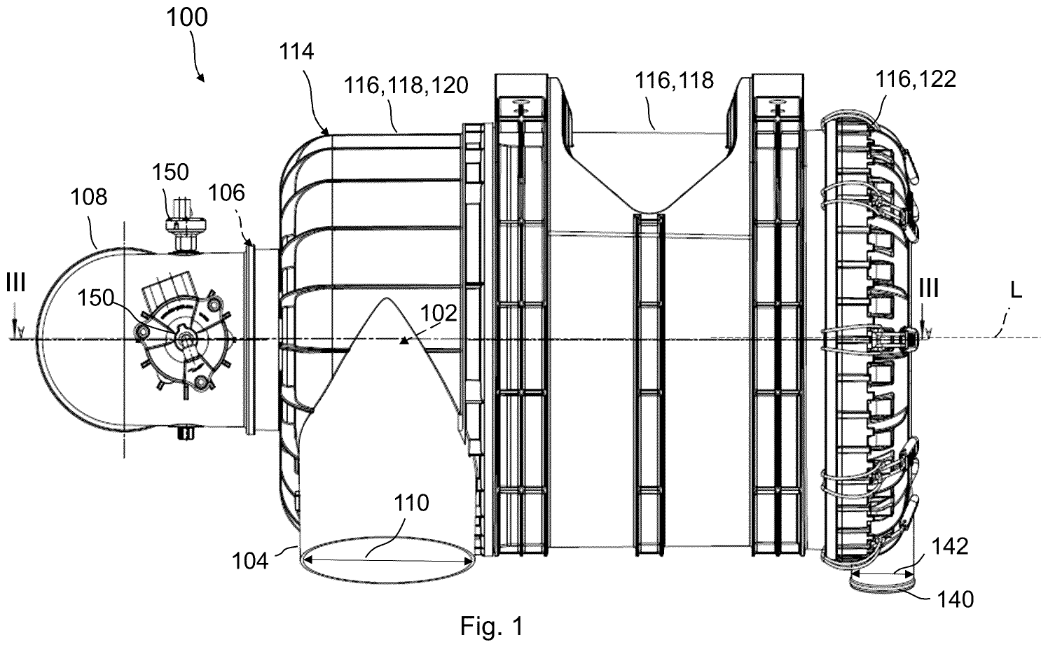

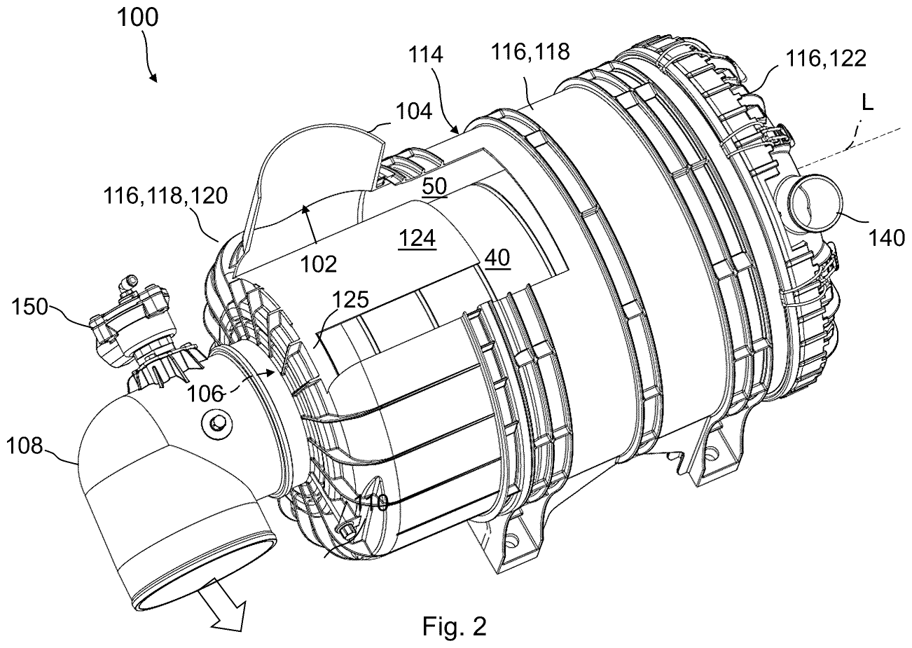

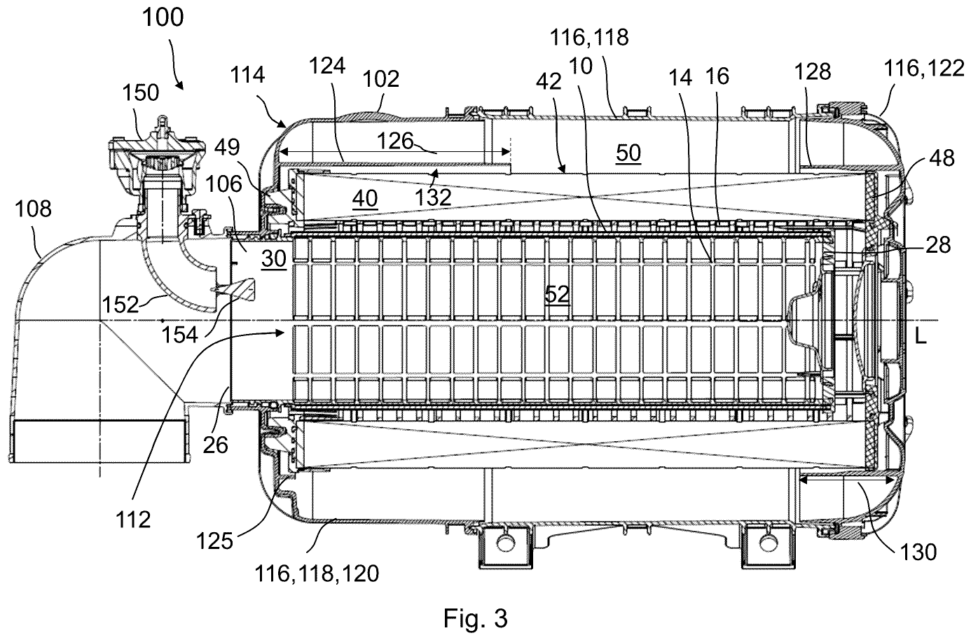

FIG. 1 shows a side view of a filter housing 114 of a filter system 100 for filtering a gaseous fluid, in particular for a self-cleaning engine intake air filter system, according to an embodiment of the invention. FIG. 2 shows a perspective view of the filter housing 114 of the filter system 100 according to FIG. 1 with partially cutaway housing wall 116. FIG. 3 shows a longitudinal section through the filter housing 114 along the line III-III in FIG. 1 with a view of a filter element 40 with secondary filter element 10 in a receiving space 112 of the filter housing 114.

The filter system 100 serves, for example, for filtering a gaseous fluid and in particular is a self-cleaning engine intake air filter system.

The filter housing 114 comprises a housing top part 118 and a housing bottom part 122 connected thereto. A housing wall 116 of the filter housing 114 comprises laterally an inlet opening 102 and a central outlet opening 106, adjoined by an inlet socket 104 and an outlet socket 108, respectively. They are arranged at a housing segment 120 of the housing top part 118. Furthermore, the filter housing 114 comprises an outlet socket 140 at the housing bottom part 122 through which particles separated from the fluid to be purified can be removed from the filter housing 114.

The housing top part 118 comprises a housing segment 120 in which the inlet opening 102 in the housing wall 116 with adjoining inlet socket 104 is arranged. The fluid to be purified flows tangentially into the filter housing 114 and thus moves in a rotational movement about the filter element 40 which is located in a receiving space 112 of the filter housing 114 and which is embodied here as a round element. Its outer side 42 is in contact with the raw side 50 and its inner side with the clean side 52. A secondary filter element 10 as a safety element is arranged within the filter element 40 embodied as a round element.

The filter element 40 comprises a closed end disk 48 at the side which is facing the housing bottom part 122. The secondary filter element 10 comprises a closed end disk 28 thereat. At the oppositely positioned side of the filter element 40, the latter comprises an open end disk 49 through which the filtered fluid flows into the outlet socket 108 through the outlet opening. Here, the secondary filter element 10 comprises an open end 26. The secondary element 10 can comprise at its side facing the filter element 40 a support element 16. The filter element 40 can comprise a central tube 14 at its inner side.

As can be seen in FIG. 2 with partially cutaway housing wall 116 in the housing section 120 with partially cutaway inlet socket 104, the filter element 40 in this region is covered by an apron-like inflow guard 124 which is spaced apart from the housing wall 116. The inflow guard 124 extends substantially only across the inlet opening 102 in the housing wall 116 while other regions of the filter element 40 are not covered. The inflow guard 124 is arranged at a circumferentially extending edge 125 of the housing 114, in particular is embodied as one piece therewith.

As can be seen in FIGS. 2 and 3, a length 126 of the inflow guard 124 in axial direction of the longitudinal axis L amounts to only a little more than an axial extension of the inlet opening 102 in the direction of the longitudinal axis L.

As can be further seen in the longitudinal section in FIG. 3, a purging device 150, of which several can be provided, is arranged at the outlet socket 108 and engages with a purging pipe 152 in the outlet socket 108. A diffuser 154 is arranged at the open end of the purging pipe 152 in a region 30 of the filter system 100 and is directed toward the interior of the filter element 40. During a cleaning procedure, the purging device 150 emits short pressure surges with a purging medium into the interior of the filter element 40 so that particles which are deposited at its outer side 42 are removed and can be removed through the outlet socket 140.

Since the filter element 40 is covered only in a relatively small region, a large surface area of the filter element 40 can be cleaned upon purging with pressure surges. Since the distance of a conventional inflow guard to the outer side 42 of the filter element 40 is relatively minimal, particles would be removed from the exterior side 42 in the covered region but would substantially remain in the gap 132 between inflow guard and filter element 40. In this way, the efficiency of the filter element 40 would be reduced.

At the closed end of the filter element 40, an additional inflow guard 128 is arranged at the housing bottom part 122. It is embodied to extend circumferentially and comprises a relatively minimal axial length 130 so that self-cleaning of the filter element 40 can be performed particularly effectively.

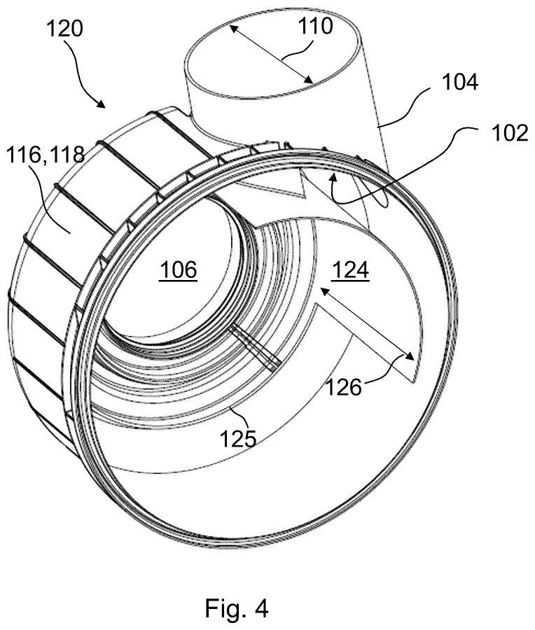

FIG. 4 shows a perspective view of the housing segment 120 of the filter housing 114 according to FIG. 1 with inlet socket 104 and inflow guard 124.

At the housing segment 120 which comprises the inlet opening 102, the inflow guard 124 is arranged which is spaced apart from the housing segment 120 in radial direction and is directed toward the receiving space 112 and extends substantially only across the inlet opening 102.

The inflow guard 124 comprises a length 126 which amounts to at most 1.5 times the axial extension of the inlet opening 102 in the housing wall 116 along a longitudinal axis L of the filter housing 114. The inflow guard 124 extends across at most 160° of the circumference of the housing segment 120.

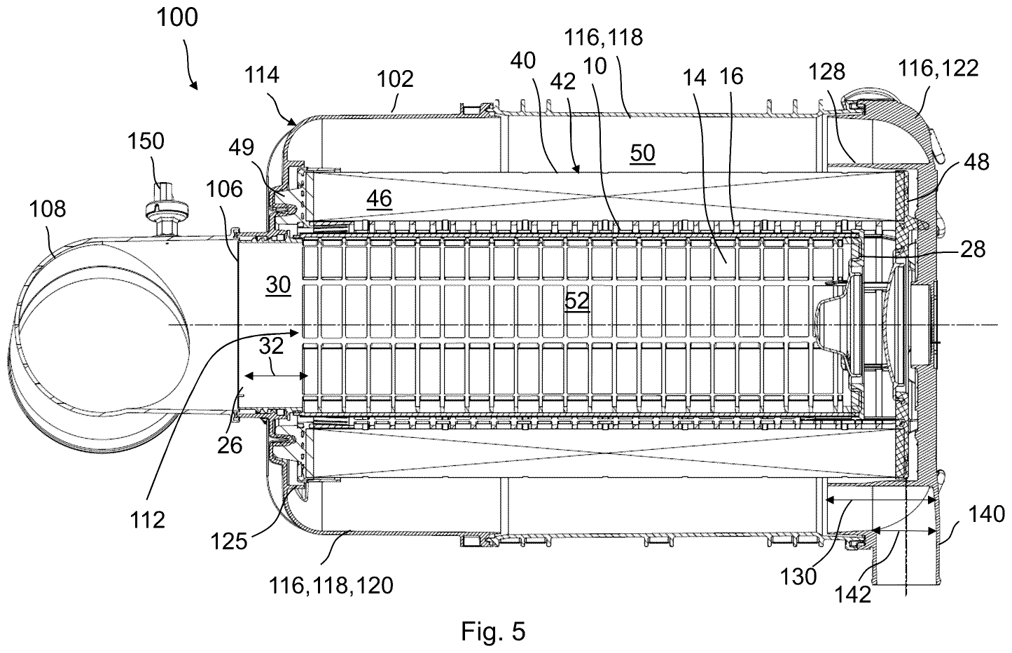

FIG. 5 shows a further longitudinal section through the filter housing 114 according to FIG. 1 in which an outlet socket 140 can be seen at the housing bottom part 122. Through it, particles can be removed from the filter housing 114.

The outlet socket 140 is covered toward the receiving space 112 by an additional inflow guard 128. The additional inflow guard 128 comprises an axial length 130 that corresponds to at most three times, preferably at most twice, an axial extension 142 of the outlet socket 140 in the housing wall 116 along the longitudinal axis L of the filter housing 114.

Accordingly, for a cleaning procedure a larger region of the outer side 42 of the filter element 40 can be freed from deposited particles.

### REFERENCE CHARACTERS

10 secondary filter element
14 central tube
16 support element
26 open end
28 end disk
30 region
32 length
40 filter element
42 inflow side
46 filter body
48 end disk
49 end disk
50 raw side
52 clean side
100 filter system
102 inlet opening
104 inlet socket
106 outlet opening
108 outlet socket
110 diameter of inlet
112 receiving space
114 filter housing
116 housing wall
118 housing top part
120 housing segment
122 housing bottom part
124 inflow guard
125 edge
126 length of inflow guard
128 inflow guard
130 length of inflow guard
132 gap
140 outlet socket
142 diameter of outlet socket
150 purging device
152 purging pipe
154 diffuser
L longitudinal axis

What is claimed is:

1. A filter housing for a filter system for filtering a gaseous fluid, the filter housing comprising:
a housing wall;
an inlet opening for a fluid to be filtered arranged in the housing wall;
an outlet opening for filtered fluid arranged in the housing wall;
a receiving space arranged inside the housing wall and configured to receive at least one filter element, wherein the at least one filter element is configured to separate a raw side from a clean side between the inlet opening and the outlet opening upon intended mounting of the at least one filter element in the filter housing;
a first housing segment in which the inlet opening is provided;
a first inflow guard arranged at the first housing segment, wherein the first inflow guard is spaced apart from the first housing segment in a radial direction of the filter housing and directed toward the receiving space, wherein the first inflow guard extends substantially only across the inlet opening.

2. The filter housing according to claim 1, wherein the first inflow guard comprises a length comprising at most 1.5 times an axial extension of the inlet opening in the housing wall along a longitudinal axis of the filter housing.

3. The filter housing according to claim 2, wherein the first inflow guard extends at most across 160° of a circumference of the housing segment.

4. The filter housing according to claim 1, wherein the first inflow guard extends at most across 160° of a circumference of the housing segment.

5. The filter housing according to claim 1, further comprising an outlet socket arranged in a second housing segment and a second inflow guard covering the outlet socket toward the receiving space.

6. The filter housing according to claim 5, wherein an axial length of the second inflow guard corresponds to at most three times an axial extension of the outlet socket in the housing wall along a longitudinal axis of the filter housing.

7. The filter housing according to claim 6, wherein the axial length of the second inflow guard corresponds to at most twice the axial extension of the outlet socket in the housing wall along the longitudinal axis of the filter housing.

8. The filter housing according to claim 5, wherein the second inflow guard extends circumferentially in relation to an inner side of the housing wall.

9. The filter housing according to claim 1, further comprising an outlet socket arranged at the outlet opening and further comprising at least one receptacle for at least one purging device arranged at the outlet socket.

10. A filter system for filtering a gaseous fluid, the filter system comprising:
a filter housing comprising a housing wall; an inlet opening for a fluid to be filtered arranged in the housing wall; an outlet opening for filtered fluid arranged in the housing wall; and a receiving space arranged inside the housing wall;
a first filter element arranged in the receiving space;
a purging device configured for intermittent emission of a pressure surge of a purging medium from a clean side of the first filter element arranged in the receiving space to a raw side of the first filter element arranged in the receiving space;
a secondary filter element arranged at the clean side of the first filter element;
a first housing segment in which the inlet opening is provided;
a first inflow guard arranged at the first housing segment, wherein the first inflow guard is spaced apart from the first housing segment in a radial direction of the filter housing and directed toward the receiving space, wherein the first inflow guard extends substantially only across the inlet opening.

11. The filter system according to claim 10, wherein the first inflow guard comprises a length comprising at most 1.5 times an axial extension of the inlet opening in the housing wall along a longitudinal axis of the filter housing.

12. The filter housing according to claim 11, wherein the first inflow guard extends at most across 160° of a circumference of the first housing segment.

13. The filter housing according to claim 10, wherein the first inflow guard extends at most across 160° of a circumference of the first housing segment.

14. The filter system according to claim 10, further comprising an outlet socket arranged in a second housing segment and a second inflow guard covering the outlet socket toward the receiving space.

15. The filter system according to claim 14, wherein an axial length of the second inflow guard corresponds to at most three times an axial extension of the outlet socket in the housing wall along a longitudinal axis of the filter housing.

16. The filter system according to claim 15, wherein the axial length of the second inflow guard corresponds to at most twice the axial extension of the outlet socket in the housing wall along the longitudinal axis of the filter housing.

17. The filter system according to claim 10, wherein the filter system is a self-cleaning engine intake air filter system.
